(19) United States
(12) Patent Application Publication
(10) Pub. No.: US 2018/0206192 A1
(43) Pub. Date: Jul. 19, 2018

(54) WAKEUP RECEIVER WAVEFORMS

(71) Applicant: QUALCOMM Incorporated, San Diego, CA (US)

(72) Inventors: Sameer Vermani, San Diego, CA (US); Bin Tian, San Diego, CA (US)

(21) Appl. No.: 15/860,883

(22) Filed: Jan. 3, 2018

Related U.S. Application Data
(60) Provisional application No. 62/447,427, filed on Jan. 17, 2017.

(51) Int. Cl. H04W 52/02; H04L 27/26

(52) U.S. Cl. CPC H04W 52/0235; H04L 27/2627

(57) ABSTRACT

Methods, systems, and devices for wireless communication are described. The method may include transmitting, at an access point (AP), a wakeup waveform comprising a first preamble portion occupying a first bandwidth, the first preamble portion comprising six (6) or more orthogonal frequency division multiplexing (OFDM) symbols, the sixth one of which is un-rotated binary phase shift keying (BPSK) modulated and transmitting a second wakeup portion of the wakeup waveform occupying a second bandwidth that is less than the first bandwidth. The method may further include receiving a preamble, the preamble occupying a first bandwidth, identifying an un-rotated BPSK modulated symbol following a first preamble portion in the received preamble, and detecting that the preamble is associated with a wakeup waveform based at least in part on the identified un-rotated BPSK modulated symbol.

### CROSS REFERENCES

The present Application for Patent claims priority to U.S. Provisional Patent Application No. 62/447,427 by Vermani, et al., entitled “Wakeup Receiver Waveforms,” filed Jan. 17, 2017, assigned to the assignee hereof.

### BACKGROUND

The following relates generally to wireless communication, and more specifically to improved wakeup receiver (WUR) waveforms.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a Wi-Fi (i.e., Institute of Electrical and Electronics Engineers (IEEE) 802.11) network may include AP that may communicate with one or more stations (STAs) or mobile devices. The access point (AP) may be coupled to a network, such as the Internet, and may enable a mobile device to communicate via the network (or communicate with other devices coupled to the access point). A wireless device may communicate with a network device bi-directionally. For example, in a WLAN, a STA may communicate with an associated AP via downlink and uplink. The downlink (or forward link) may refer to the communication link from the AP to the STA, and the uplink (or reverse link) may refer to the communication link from the STA to the AP.

A wireless device may have a limited amount of battery power. In some cases, it may be beneficial for a primary radio (e.g., of the wireless device) to remain in a sleep mode or low power mode for extended periods of time. During a sleep mode, a wireless device may periodically activate a radio, such as a WUR, to listen for and decode a wakeup signal from an AP. In some examples, the wakeup signal may be a signal of reduced code rate and/or bandwidth (e.g., a narrowband signal), and may be used to indicate whether communications are waiting at the AP to be transmitted to the wireless device. The wireless device may then power on the primary radio based on receiving the wakeup signal.

In some cases, other wireless devices (e.g., neighbor or bystander wireless devices) may misinterpret a wakeup waveform having a wider band preamble (e.g., a legacy preamble) and a narrowband wakeup portion. For example, a wireless device listening for signals directed to it may monitor a wider band, and successfully receive a legacy preamble, and may then misinterpret a portion of the narrowband wakeup signal as another type of signal (e.g., a 802.11n waveform) due to empty tone noise on either side of the narrowband wakeup portion. False detection prevention schemes and improved coexistence techniques for indicating an upcoming wakeup signal may be desired.

### SUMMARY

The described techniques relate to improved methods, systems, devices, or apparatuses that support improved wakeup receiver waveforms. A wakeup waveform to be transmitted by an access point (AP) may have a preamble, including a first preamble portion and a second preamble portion (such as a buffer portion), and a wakeup portion including a wakeup message. The first preamble portion may include a legacy short training field, a legacy long training field and a legacy signal field (which may be for example 5 symbols in total). The preamble may be followed by an un-rotated binary phase shift keying (BPSK) symbol (for example the sixth symbol), that may indicate to bystander stations or wireless devices (e.g., that are not the intended recipients of the wakeup waveform) that it is a wakeup waveform (e.g., and not a 802.11n waveform), such that the bystander devices may respect the legacy signal field (L-SIG) duration specified in the preamble. Wireless devices or stations (STAs) that are the intended recipients of the wakeup portion of the wakeup waveform, may be unaware of the preamble, but receive the wakeup portion, including a wakeup preamble (including sync) and wakeup message bits. The wakeup message bits may be used by the intended recipient to wake up its primary radio to communicate with the AP transmitting the wakeup waveform. Information usable by the bystander devices may be conveyed by the un-rotated BPSK symbol, including additional subsequent un-rotated BPSK symbols.

A method of wireless communication is described. The method may include transmitting, at an AP, a wakeup waveform comprising a first preamble portion occupying a first bandwidth, the first preamble portion comprising six (6) or more orthogonal frequency division multiplexing (OFDM) symbols, the sixth one of which is un-rotated BPSK modulated, and transmitting a second wakeup portion of the wakeup waveform occupying a second bandwidth that is less than the first bandwidth.

An apparatus for wireless communication is described. The apparatus may include means for transmitting, at an AP, a wakeup waveform comprising a first preamble portion occupying a first bandwidth. In some cases, the first preamble portion may comprise six or more OFDM symbols, the sixth one of which is un-rotated BPSK modulated. The apparatus may further include means for transmitting a second wakeup portion of the wakeup waveform occupying a second bandwidth that is less than the first bandwidth.

Another apparatus for wireless communication is described. The apparatus may include a processor, memory in electronic communication with the processor, and instructions stored in the memory. The instructions may be operable to cause the processor to transmit, at an AP, a wakeup waveform comprising a first preamble portion occupying a first bandwidth. In some cases, the first preamble portion may comprise six or more OFDM symbols, the sixth one of which is un-rotated BPSK modulated. The instructions may be further operable to cause the processor to transmit a second wakeup portion of the wakeup waveform occupying a second bandwidth that is less than the first bandwidth.

A non-transitory computer readable medium for wireless communication is described. The non-transitory computer-readable medium may include instructions operable to cause a processor to transmit, at an AP, a wakeup waveform comprising a first preamble portion occupying a first bandwidth. In some cases, the first preamble portion may comprise six or more OFDM symbols, the sixth one of which is un-rotated BPSK modulated. The non-transitory computer-readable medium may include further instructions operable to cause a processor to transmit a second wakeup portion of the wakeup waveform occupying a second bandwidth that is less than the first bandwidth.

In some examples of the method, apparatus, and non-transitory computer-readable medium described above, the first preamble portion includes a legacy short training field, a legacy long training field and a legacy signal field. In some examples of the method, apparatus, and non-transitory computer-readable medium described above, the length indication in the legacy signal field may be not a multiple of 3.

In some examples of the method, apparatus, and non-transitory computer-readable medium described above, the first bandwidth may be 20 MHz. In some examples of the method, apparatus, and non-transitory computer-readable medium described above, the second bandwidth may be less than 5 MHz.

In some examples of the method, apparatus, and non-transitory computer-readable medium described above, the first preamble portion may be targeted to one or more bystander stations. In some examples of the method, apparatus, and non-transitory computer-readable medium described above, the symbols in the first preamble portion after the fifth OFDM symbol may carry an identifier for a subset of the one or more bystander stations to detect the waveform as the wakeup waveform (e.g., the wakeup waveform as the wakeup waveform). In some examples of the method, apparatus, and non-transitory computer-readable medium described above, the identifier consists of one or more cyclic redundancy check (CRC) bits, a masked repeated legacy signal field (RL-SIG) as the sixth symbol, or a combination thereof. In some examples of the method, apparatus, and non-transitory computer-readable medium described above, the symbols in the first preamble portion after the fifth OFDM symbol may carry information for the subset of the one or more bystander stations. In some examples of the method, apparatus, and non-transitory computer-readable medium described above, the information comprises a basic service set (BSS) color as defined in Institute of Electrical and Electronics Engineers (IEEE) 802.11ax or another BSS identifier. In some examples of the method, apparatus, and non-transitory computer-readable medium described above, the sixth OFDM symbol may be different than the fifth OFDM symbol.

A method of wireless communication is described. The method may include transmitting, in a first bandwidth, a preamble of a wakeup waveform including a first preamble portion followed by a second preamble portion comprising an un-rotated BPSK modulated symbol and transmitting, to a wakeup radio of a station and following the preamble occupying the first bandwidth, a wakeup signal of the wakeup waveform occupying a second bandwidth, the second bandwidth less than the first bandwidth.

An apparatus for wireless communication is described. The apparatus may include means for transmitting, in a first bandwidth, a preamble of a wakeup waveform including a first preamble portion followed by a second preamble portion comprising an un-rotated BPSK modulated symbol and means for transmitting, to a wakeup radio of a station and following the preamble occupying the first bandwidth, a wakeup signal of the wakeup waveform occupying a second bandwidth, the second bandwidth less than the first bandwidth.

Another apparatus for wireless communication is described. The apparatus may include a processor, memory in electronic communication with the processor, and instructions stored in the memory. The instructions may be operable to cause the processor to transmit, in a first bandwidth, a preamble of a wakeup waveform including a first preamble portion followed by a second preamble portion comprising an un-rotated BPSK modulated symbol. The instructions may be further operable to cause the processor to transmit, to a wakeup radio of a station and following the preamble occupying the first bandwidth, a wakeup signal of the wakeup waveform occupying a second bandwidth, the second bandwidth less than the first bandwidth.

A non-transitory computer readable medium for wireless communication is described. The non-transitory computer-readable medium may include instructions operable to cause a processor to transmit, in a first bandwidth, a preamble of a wakeup waveform including a first preamble portion followed by a second preamble portion comprising an un-rotated BPSK modulated symbol. The non-transitory computer-readable medium may include instructions further operable to cause a processor to transmit, to a wakeup radio of a station and following the preamble occupying the first bandwidth, a wakeup signal of the wakeup waveform occupying a second bandwidth, the second bandwidth less than the first bandwidth. In some examples of the method, apparatus, and non-transitory computer-readable medium described above, the second preamble portion comprises an indication of a presence of the wakeup signal following the preamble.

A method of wireless communication is described. The method may include receiving a preamble, the preamble occupying a first bandwidth, identifying an un-rotated BPSK modulated symbol following a first preamble portion in the received preamble, and detecting that the preamble is associated with a wakeup waveform based at least in part on the identified un-rotated BPSK modulated symbol.

An apparatus for wireless communication is described. The apparatus may include means for receiving a preamble, the preamble occupying a first bandwidth, means for identifying an un-rotated BPSK modulated symbol following a first preamble portion in the received preamble, and means for detecting that the preamble is associated with a wakeup waveform based at least in part on the identified un-rotated BPSK modulated symbol.

Another apparatus for wireless communication is described. The apparatus may include a processor, memory in electronic communication with the processor, and instructions stored in the memory. The instructions may be operable to cause the processor to receive a preamble, the preamble occupying a first bandwidth, identify an un-rotated BPSK modulated symbol following a first preamble portion in the received preamble, and detect that the preamble is associated with a wakeup waveform based at least in part on the identified un-rotated BPSK modulated symbol.

A non-transitory computer readable medium for wireless communication is described. The non-transitory computer-readable medium may include instructions operable to cause a processor to receive a preamble, the preamble occupying a first bandwidth, identify an un-rotated BPSK modulated symbol following a first preamble portion in the received preamble, and detect that the preamble is associated with a wakeup waveform based at least in part on the identified un-rotated BPSK modulated symbol.

In some examples of the method, apparatus, and non-transitory computer-readable medium described above, the preamble comprises six or more OFDM symbols, the sixth OFDM symbol being the un-rotated BPSK modulated symbol.

In some examples of the method, apparatus, and non-transitory computer-readable medium described above, the first preamble portion includes a legacy short training field, a legacy long training field and a legacy signal field. In some examples of the method, apparatus, and non-transitory computer-readable medium described above, the length indication in the legacy signal field may be not a multiple of 3. In some examples of the method, apparatus, and non-transitory computer-readable medium described above, the first bandwidth may be 20 MHz.

In some examples of the method, apparatus, and non-transitory computer-readable medium described above, the first preamble portion may be targeted to the station. In some examples of the method, apparatus, and non-transitory computer-readable medium described above, the symbols in the first preamble portion after the fifth OFDM symbol carry an identifier for the station to detect the waveform as the wakeup waveform. In some examples of the method, apparatus, and non-transitory computer-readable medium described above, the identifier consists of one or more CRC bits, a masked RL-SIG as the sixth symbol, or a combination thereof. In some examples of the method, apparatus, and non-transitory computer-readable medium described above, the symbols in the first preamble portion after the fifth OFDM symbol carry information for the station. In some examples of the method, apparatus, and non-transitory computer-readable medium described above, the information comprises a BSS color as defined in IEEE 802.11ax or another BSS identifier. In some examples of the method, apparatus, and non-transitory computer-readable medium described above, the sixth OFDM symbol may be different than the fifth OFDM symbol.

### BRIEF DESCRIPTION OF THE DRAWINGS

FIG. 1 illustrates an example of a system for wireless communication that supports improved wakeup receiver waveforms in accordance with aspects of the present disclosure.

FIG. 2 illustrates an example of a wireless communications system that supports improved wakeup receiver waveforms in accordance with various aspects of the present disclosure.

FIG. 3 illustrates an example of a wakeup waveform in accordance with one or more aspects of the present disclosure.

FIG. 4 illustrates a process flow for improved wakeup receiver waveforms in accordance with one or more aspects of the present disclosure.

FIGS. 5 through 7 show block diagrams of a device that supports improved wakeup receiver waveforms in accordance with aspects of the present disclosure.

FIG. 8 illustrates a block diagram of a system including an access point (AP) that supports improved wakeup receiver waveforms in accordance with aspects of the present disclosure.

FIGS. 9 through 11 show block diagrams of a device that supports improved wakeup receiver waveforms in accordance with aspects of the present disclosure.

FIG. 12 illustrates a block diagram of a system including a station (STA) that supports improved wakeup receiver waveforms in accordance with aspects of the present disclosure.

FIGS. 13 through 15 illustrate methods for improved wakeup receiver waveforms in accordance with aspects of the present disclosure.

### DETAILED DESCRIPTION

In some cases, a wireless device may include a primary radio configured to communicate with a wakeup radio. An access point (AP) may send a wakeup signal to a wakeup receiver (WUR), indicating that the primary radio has some data to receive. A WUR may listen for and receive the wakeup signal, and may provide the primary radio with an indication to wake up to receive the pending data.

In some cases, wakeup waveforms from an AP may include a legacy preamble followed by a narrowband wakeup signal. Bystander wireless devices (e.g., wireless devices not explicitly listening for a wakeup signal with a WUR) may misinterpret the preamble and/or wakeup signal, and may falsely classify the wakeup waveform (e.g., as a 802.11n waveform). For example, a bystander wireless device may monitor over a bandwidth (e.g., 20 MHz) and interpret the signal associated with the narrowband wakeup signal (e.g., 5 MHz) in addition to empty tone noise (e.g., noise surrounding the narrowband wakeup signal in the remainder of the monitored 20 MHz bandwidth). As a result, the bystander wireless device may misinterpret the wakeup waveform as, for example, a different type of waveform (e.g., a 802.11n waveform), a failed cyclic redundancy check (CRC), etc. That is, a bystander wireless device may falsely identify the wakeup waveform as an 802.11n waveform. The device may then search for a high throughput signal field (HT-SIG) CRC. As the waveform is not actually an 802.11n waveform, the HT-SIG CRC may fail, resulting in the bystander device not respecting the legacy signal field (L-SIG) duration once the HT-SIG fails (e.g., the bystander device may resume energy detection). Such waveform misinterpretations or false classifications may lead to random deferrals, lack of proper wakeup signal observance (e.g., transmission collisions), etc.

One or more buffer symbols may be added to the preamble of a wakeup waveform to indicate the upcoming wakeup signal and reduce false transmission detections by other bystander wireless devices. For example, the first symbol included in the preamble may be binary phase shift keying (BPSK) modulated (e.g., an un-rotated BPSK symbol). Bystander wireless devices (e.g., wireless devices not associated with the wakeup signal of the wakeup waveform) may receive the BPSK modulated first symbol, and determine they are unintended receivers of the signal (e.g., the wakeup signal). These unintended (e.g., bystander) wireless devices may thus avoid falsely classifying the wakeup signal and may respect the duration of the wakeup signal (e.g., as indicated in a preamble field of the wakeup waveform such as a L-SIG). That is, a bystander wireless device (e.g., that not an intended recipient of a wakeup signal) may identify an un-rotated BPSK symbol, avoid false detection of a 802.11n waveform (e.g., by classifying the waveform as an 802.11a waveform), and respect the indicated L-SIG duration. In some cases, additional symbols (e.g., buffer symbols following the first BPSK modulated buffer symbol) may be included in the wakeup waveform to convey additional information to bystander wireless devices.

Aspects of the disclosure are initially described in the context of a wireless communications system. Aspects of the disclosure are also described in the context of example wakeup waveform structures. Aspects of the disclosure are further illustrated by and described with reference to apparatus diagrams, system diagrams, and flowcharts that relate to improved wakeup receiver waveforms.

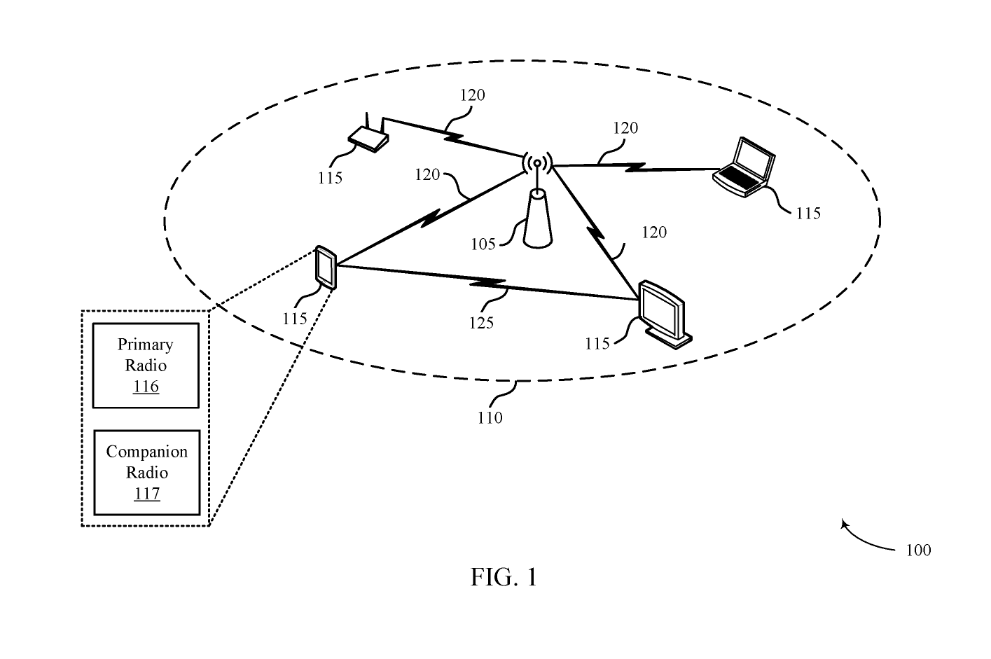

FIG. 1 illustrates a wireless local area network (WLAN) 100 (also known as a Wi-Fi network) configured in accordance with various aspects of the present disclosure. The WLAN 100 may include an AP 105 and multiple associated wireless devices or stations (STAs) 115, which may represent devices such as wireless communication terminals, including mobile stations, phones personal digital assistant (PDAs), other handheld devices, netbooks, notebook computers, tablet computers, laptops, display devices (e.g., TVs, computer monitors, etc.), printers, etc. The AP 105 and the associated STAs 115 may represent a basic service set (BSS) or an extended service set (ESS). The various STAs 115 in the network are able to communicate with one another through the AP 105. Also shown is a coverage area 110 of the AP 105, which may represent a basic service area (BSA) of the WLAN 100. An extended network station associated with the WLAN 100 may be connected to a wired or wireless distribution system that may allow multiple APs 105 to be connected in an ESS. WLAN 100 may support media access control (MAC) for wakeup radio.

A STA 115 may include a primary radio 116 and a low power companion radio 117 for communication. The primary radio 116 may be used during active modes (e.g., full power modes) or for high-data throughput applications. The low-power companion radio 117 may be used during low-power modes or for low-throughput applications. In some examples, the low-power companion radio 117 may be a WUR.

A STA 115 may listen using a wakeup radio, such as companion radio 117, for a wakeup message (wakeup portion) in a wakeup waveform. STA 115 may receive a preamble having a first bandwidth (e.g., wideband) and a wakeup signal having a second bandwidth (e.g., narrowband).

A STA 115 may be located in the intersection of more than one coverage area 110 and may associate with more than one AP 105. A single AP 105 and an associated set of STAs 115 may be referred to as a BSS. An ESS is a set of connected BSSs. A distribution system may be used to connect APs 105 in an ESS. In some cases, the coverage area 110 of an AP 105 may be divided into sectors. The WLAN 100 may include APs 105 of different types (e.g., metropolitan area, home network, etc.), with varying and overlapping coverage areas 110. Two STAs 115 may also communicate directly via a direct wireless link 125 regardless of whether both STAs 115 are in the same coverage area 110. Examples of direct wireless links 120 may include Wi-Fi Direct connections, Wi-Fi Tunneled Direct Link Setup (TDLS) links, and other group connections. STAs 115 and APs 105 may communicate according to the WLAN radio and baseband protocol for physical and MAC layers from Institute of Electrical and Electronics Engineers (IEEE) 802.11 and versions including, but not limited to, 802.11b, 802.11g, 802.11a, 802.11n, 802.11ac, 802.11ad, 802.11ah, 802.11ax, etc. In other implementations, peer-to-peer connections or ad hoc networks may be implemented within WLAN 100. Devices in WLAN 100 may communicate over unlicensed spectrum, which may be a portion of spectrum that includes frequency bands traditionally used by Wi-Fi technology, such as the 5 GHz band, the 2.4 GHz band, the 60 GHz band, the 3.6 GHz band, and/or the 900 MHz band. The unlicensed spectrum may also include other frequency bands.

In some cases, a STA 115 (or an AP 105) may be detectable by a central AP 105, but not by other STAs 115 in the coverage area 110 of the central AP 105. For example, one STA 115 may be at one end of the coverage area 110 of the central AP 105 while another STA 115 may be at the other end. Thus, both STAs 115 may communicate with the AP 105, but may not receive the transmissions of the other. This may result in colliding transmissions for the two STAs 115 in a contention based environment (e.g., carrier sense multiple access with collision avoidance (CSMA/CA)) because the STAs 115 may not refrain from transmitting on top of each other. A STA 115 whose transmissions are not identifiable, but that is within the same coverage area 110 may be known as a hidden node. CSMA/CA may be supplemented by the exchange of a request to send (RTS) packet transmitted by a sending STA 115 (or AP 105) and a clear to send (CTS) packet transmitted by the receiving STA 115 (or AP 105). This may alert other devices within range of the sender and receiver not to transmit for the duration of the primary transmission. Thus, RTS/CTS may help mitigate a hidden node problem.

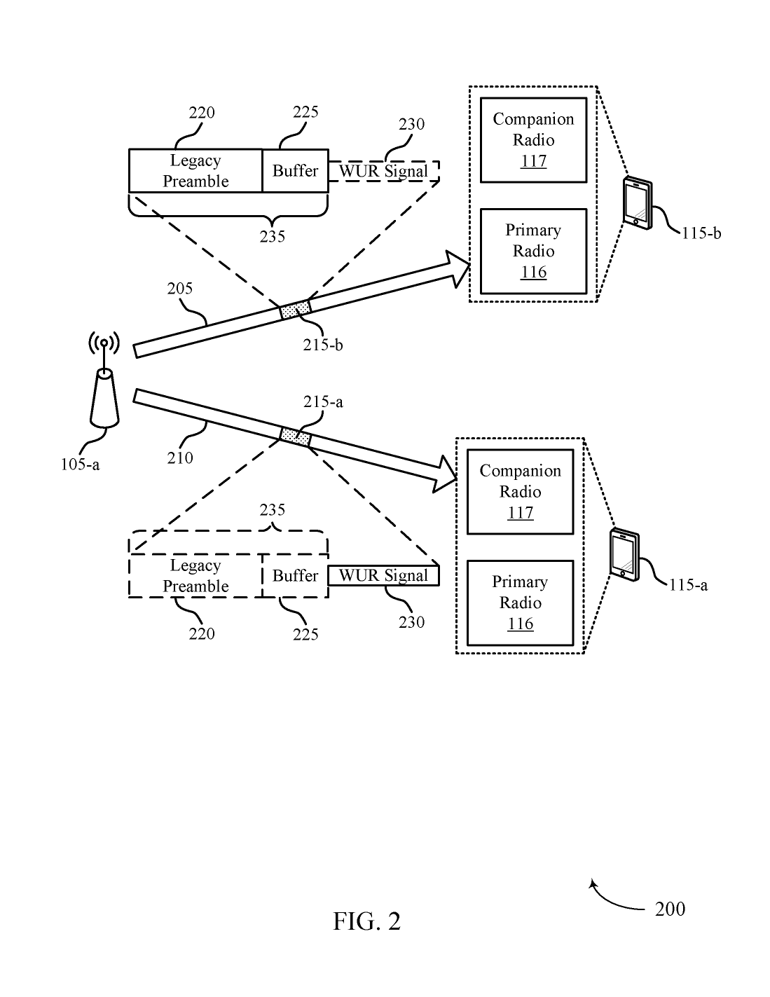

FIG. 2 illustrates an example of a wireless communications system 200 that supports improved wakeup receiver waveforms in accordance with various aspects of the present disclosure. Wireless communications system 200 may include an AP 105-a and a STA 115-a, which may be examples of the corresponding devices described with reference to FIG. 1. STA 115-a may include a primary radio 116 and a companion radio 117 for communications with AP 105-a, other STAs 115, etc. The primary radio 116 may be used during active modes or for high-data throughput applications. The low-power companion radio 117 may be used during low-power modes or for low-throughput applications. In some examples, the low-power companion radio 117 may be a WUR. The low-power companion radio 117 may listen for wakeup waveforms 215, wakeup portions 230, wakeup messages, etc.

A primary radio 116 of the STA 115-a may be configured to have a high-throughput of data. A communication link 210 may be established between the AP 105-a and the low power companion radio 117 of the STA 115-a. The communication link may be configured to conserve power during communications. The communication link 210 may be an example of a wireless links 120 described with reference to FIG. 1. In some cases, to avoid unnecessarily expending power, primary radio 116 may remain in a sleep mode or low power mode for an extended period of time. During a sleep mode, STA 115-a may periodically activate companion radio 117, which may be a WUR, to listen for and decode a wakeup waveform 215 from AP 105-b. Wakeup waveform 215, for example wakeup portion 230, may indicate to companion radio 117 whether communications are waiting at AP 105-a to be transmitted to STA 115-a. STA 115-a may then power on primary radio 116 in response to wakeup waveform 215 received at companion radio 117 (e.g., to receive the communications waiting at the AP 105-a via the powered primary radio 116).

A wakeup signal may be a physical layer conversion protocol (PLCP) protocol data unit (PPDU). A preamble may be transmitted over a certain bandwidth (e.g., a channel, such as a 20 MHz channel), to be understandable by neighboring devices. However, the following wakeup signal may use a narrower bandwidth (e.g., 5 MHz or less). If wakeup waveform 215 spans the entire, wider bandwidth of the preamble, companion radio 117 may require or consume more power than necessary for a companion radio 117 to receive and decode wakeup waveform 215. Thus, a wakeup waveform preamble 235 may include a legacy preamble 220 and a buffer 225 transmitted on a wide band, while, the portion of wakeup waveform 215 that contains the wakeup message (e.g., wakeup portion 230) may be transmitted on a narrow band, which may require less power to receive at companion radio 117. Thus, transmission power may be saved, and interference reduced. The companion radio, listening on a narrowband, may receive and respond to narrowband wakeup portion 230 but be unaware of the preamble 235.

In some examples, it may be desirable for other, bystander devices (e.g., bystander STA 115-b) to be aware of a wakeup portion 230, so that the medium for the transmission of wakeup waveform 215 may be reserved and interference may be prevented. Wakeup waveform 215-b represents wakeup waveform 215-a as experienced at bystander STA 115-b on communication link 205. Coexistence issues may arise when preexisting devices already in deployment are not aware of wakeup waveform technology and/or when devices that communicate according to other versions of IEEE radio and baseband protocols (e.g., 802.11n, 802.11ac, 802.11ax devices) misinterpret the preamble 235 together with the narrowband wakeup portion 230 of the wakeup waveform. Including an (un-rotated) BPSK modulated symbol in the buffer portion of the preamble 235 (e.g., in buffer 225) following the legacy preamble portion (e.g., legacy preamble 220) may ensure bystander wireless devices (e.g., a bystander STA 115-b) stay off the medium for the duration of the wakeup waveform 215 (e.g., such a buffer may ensure bystander wireless devices do not falsely classify the wakeup waveform due to noise or other influence of the wakeup portion 230, and ensure bystander wireless devices respect the L-SIG duration indicated in the legacy preamble 220).

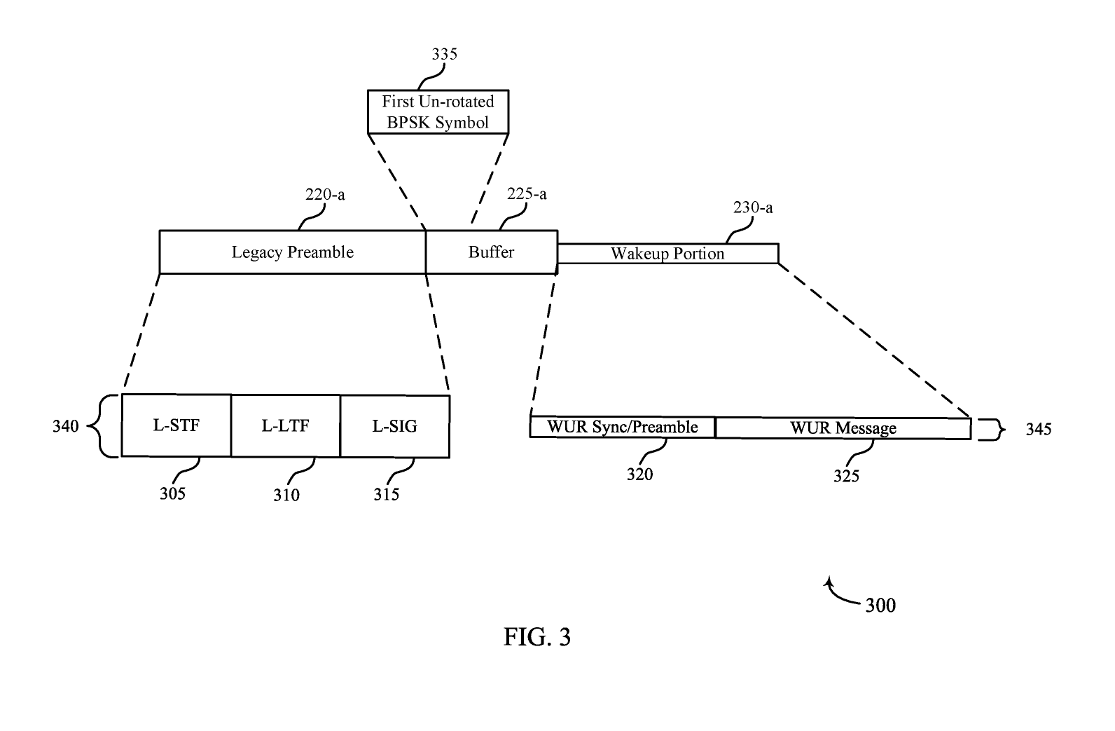

FIG. 3 illustrates an example of a wakeup waveform 300 in accordance with one or more aspects of the present disclosure. In some cases, wakeup waveform 300 may represent aspects of techniques performed by a STA 115 or an AP 105 as described with reference to FIGS. 1-2. In some examples, a wakeup waveform 300 may include a legacy preamble portion, a buffer preamble portion, and a wakeup signal portion.

Other legacy devices (e.g., bystander wireless devices) may defer the medium for transmission of wakeup portion 230-a upon receiving and decoding legacy preamble 220-a. For example, the legacy preamble 220-a may include an legacy short training field (L-STF) 305, a legacy long training field (L-LTF) field 310, and a L-SIG field 315. Upon receiving and decoding these fields, bystander wireless devices may understand that the medium is to be occupied for a particular period of time, as specified by the preamble, and may thus refrain from transmitting during transmission of the wakeup portion 230-a. In particular, bystander wireless devices may calculate a length for the wakeup signal transmission using data rate and length information encoded in the L-SIG field 315 that indicates the duration of the transmissions, and thus the duration of the wakeup signal transmission following the preamble. Other configurations of fields for the preamble may be used in other examples, for example to maintain compatibility with other protocols, including future Wi-Fi protocols.

The legacy preamble 220-a may be transmitted on a wider bandwidth 340 than the wakeup portion 230-a. The wider bandwidth 340 may be a Wi-Fi channel width (e.g., 20 MHz, 40 MHz, etc.). The wakeup portion 230-a may include a WUR sync/preamble 320 and WUR message bits 325. In some examples, the wakeup portion of the wakeup waveform may be transmitted on a narrow bandwidth 345, which may require less power to receive at the WUR. In some examples the narrow bandwidth may be a bandwidth less than the wider bandwidth associated with a legacy device, for example 5 MHz or less. That is, during the wakeup portion 230-a, there may only be a few tones of valid information within wider bandwidth 340 (e.g., only ¼ of tones may contain valid information). Without techniques described herein (e.g., buffer symbols in the wakeup waveform preamble), bystander wireless devices may unreliably interpret the wakeup portion 230-a due to noise, such as empty tone noise, within the monitored wider bandwidth 340.

Consider an example of a bystander wireless device operating under an IEEE 802.11n protocol. Upon receiving an L-SIG field 315, such a device may search for a quadrature binary phase shift keying (Q-BPSK) HT-SIG field. Due to empty tone noise discussed above, the bystander wireless device may trigger a false positive on the Q-BPSK check (e.g., falsely detect a Q-BPSK symbol) and determine the signal is an 802.11n protocol signal. According to IEEE 802.11n protocol, the bystander wireless device may then try to check for an HT-SIG CRC. Failure of such CRC may force the bystander wireless device into an energy detect mode, effectively ignoring the duration previously indicated by L-SIG field 315. Upon entering the energy detect mode, the bystander wireless device may circumstantially (e.g., based on detected energies, a buffer status, etc.) attempt to access the medium, resulting in potential collisions with wakeup portion 230-a. In some cases, energy detect may be less sensitive (e.g., to triggering criteria) than preamble detect, therefore the chances of missing an ongoing transmission may be increased. Such false detections and random deferrals may be alleviated by including one or more BPSK modulated symbols in the preamble. One or more BPSK modulated buffer symbols (e.g., a first un-rotated BPSK symbol 335-a) following the L-SIG field 315 may greatly decrease the chance a bystander wireless device obtains a false positive on a Q-BPSK (e.g., a rotated BPSK) check. That is, following the L-SIG field 315, Q-BPSK checks over a bandwidth including one or more BPSK modulated symbols may greatly reduce the occurrence of false positive Q-BPSK checks compared to Q-BPSK checks over a bandwidth including a wakeup signal and empty tone noise. Thus, the BPSK modulated symbol (e.g., the un-rotated BPSK symbol) may ensure bystander wireless devices that the wakeup waveform is not misclassified as some other IEEE protocol waveform (e.g., that 802.11n devices may interpret and/or classify the wakeup waveform as a 802.11a packet, and not as a 802.11n waveform).

Additional preamble design considerations may be taken into account to ensure other bystander wireless device operating under different IEEE protocols are aware of the wakeup portion 230. For example, a bystander wireless device operating under an IEEE 802.11ac protocol may expect a length indication (e.g., in a L-SIG field 315) to be a multiple of 3 (e.g., a length indication that is a multiple of 3 bytes). Therefore, the preamble may be designed to not indicate certain lengths in the L-SIG field, in addition to including BPSK modulated buffer symbols, for example by having the length indication not be 3 (e.g., or a multiple of 3). Further, a bystander wireless device operating under an IEEE 802.11ax protocol may expect an exact copy of the L-SIG field, at a symbol location following the L-SIG field (e.g., a repeated legacy signal field (RL-SIG) field). Therefore, the buffer symbols included in the preamble may be designed to explicitly avoid duplication of the L-SIG field. False detection prevention schemes described herein may be applied to bystander wireless devices communicating over other IEEE protocols such that the preamble may be designed to indicate, implicitly or explicitly, that the transmission (e.g., wakeup signal) is not intended for the bystander wireless device. That is false detection prevention schemes described herein may allow for bystander wireless devices to detect or identify the wakeup waveform as a wakeup waveform.

The one or more symbols of buffer 225 may carry additional information for bystander wireless devices that are aware of such transmissions (e.g., aware of wakeup waveform 215-like waveforms). For example, one symbol may carry information such as BSS color (e.g., 24 bits indicating a BSS identifier (BSSID)). In order for bystander wireless devices to be aware the waveform is a wakeup signal, CRC may be performed on the buffer symbol to check its content. Additionally or alternatively, an RL-SIG may be used with a masking sequence to indicate the waveform is a wakeup signal.

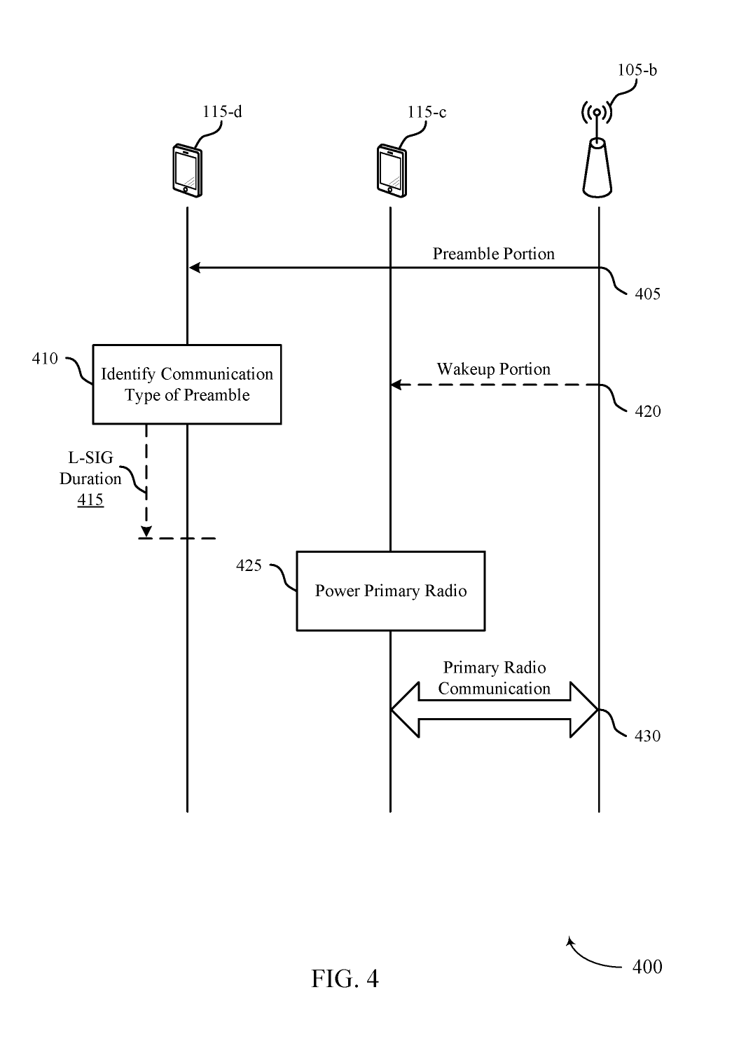

FIG. 4 illustrates a process flow 400 for improved wakeup receiver waveforms in accordance with one or more aspects of the present disclosure. Process flow 400 may represent aspects of techniques performed by a STA 115 or an AP 105 as described with reference to FIGS. 1-3. Process flow 400 may illustrate how a bystander wireless device (e.g., STA 115-d) and a wireless device intended for a wakeup signal (e.g., STA 115-c) may respond and/or react to a wakeup waveform from AP 105-b, according to techniques as described herein.

At 405, a preamble portion of the wakeup waveform may be transmitted. Bystander STA 115-d may receive the preamble portion, including a legacy preamble portion and one or more un-rotated QPSK symbols following the preamble portion. At 410, the bystander device (e.g., STA 115-d) may identify the communciation type of the wakeup waveform based on the received preamble, and may not misclassify the wakeup waveform as 802.11n (e.g., classify the preamble as for a 802.11 waveform). The bystander STA 115-d may then defer the medium for the L-SIG duration 415 as indicated by the preamble.

At 420, which is after the preamble portion is transmitted, but may be before, concurrently with, or after 410, the wakeup portion of the wakeup waveform may be transmitted. The intended recipient of the wakeup portion, STA 115-c, may receive the wakeup portion. In some cases, STA 115-c may not be aware of the transmission of the preamble portion 405 (e.g., because STA 115-c may be listening using a low power WUR on a narrowband). If STA 115-c determines that it is the intended recipient of the wakeup portion (e.g., by receiving and decoding a wakeup message of the wakeup portion of the wakeup waveform), at 425, STA 115-c may power up its primary radio in response and communicate with AP 105-b at 430.

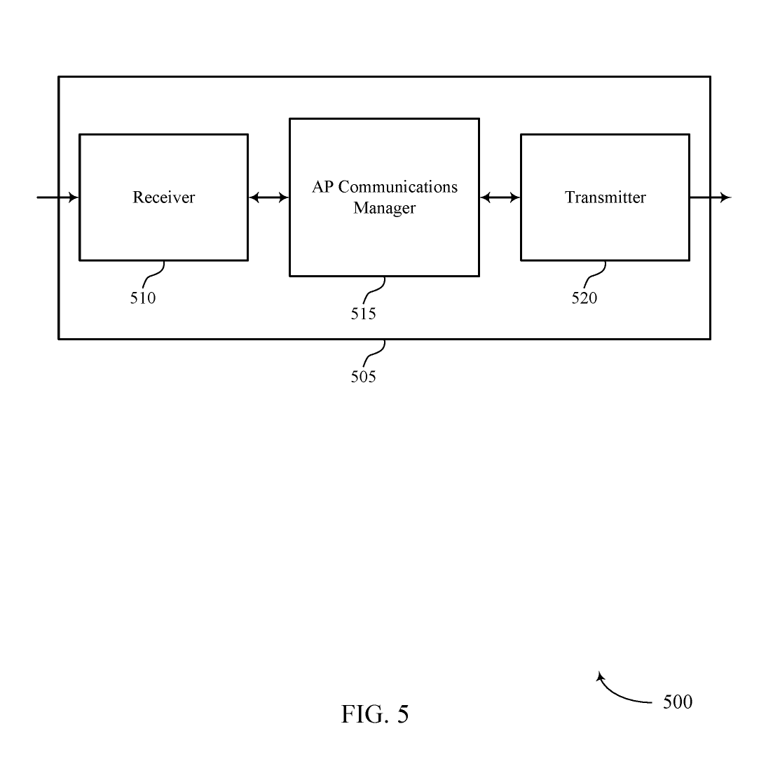

FIG. 5 shows a block diagram 500 of a wireless device 505 that supports improved wakeup receiver waveforms in accordance with various aspects of the present disclosure. Wireless device 505 may be an example of aspects of an AP 105 as described with reference to FIG. 1. Wireless device 505 may include receiver 510, AP communications manager 515, and transmitter 520. Wireless device 505 may also include a processor. Each of these components may be in communication with one another (e.g., via one or more buses).

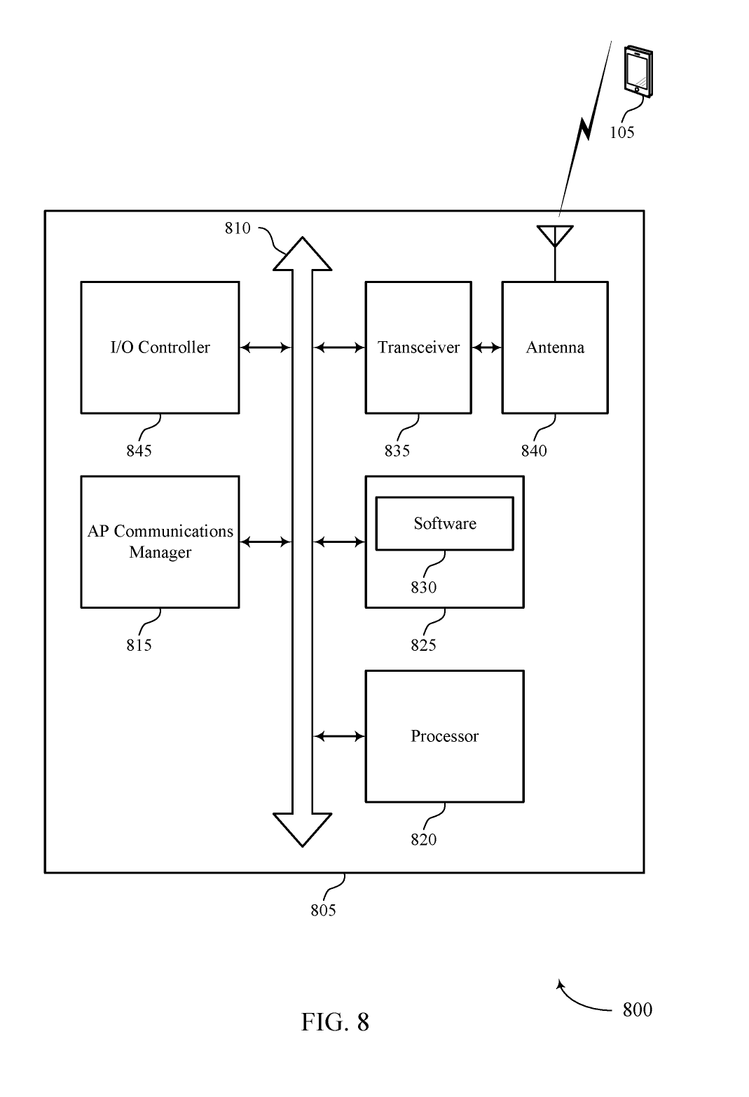

Receiver 510 may receive information such as packets, user data, or control information associated with various information channels (e.g., control channels, data channels, and information related to improved wakeup receiver waveforms, etc.). Information may be passed on to other components of the device. The receiver 510 may be an example of aspects of the transceiver 835 described with reference to FIG. 8.

AP communications manager 515 may be an example of aspects of the AP communications manager 815 described with reference to FIG. 8. AP communications manager 515 and/or at least some of its various sub-components may be implemented in hardware, software executed by a processor, firmware, or any combination thereof. If implemented in software executed by a processor, the functions of the AP communications manager 515 and/or at least some of its various sub-components may be executed by a general-purpose processor, a digital signal processor (DSP), an application-specific integrated circuit (ASIC), an field-programmable gate array (FPGA) or other programmable logic device, discrete gate or transistor logic, discrete hardware components, or any combination thereof designed to perform the functions described in the present disclosure. The AP communications manager 515 and/or at least some of its various sub-components may be physically located at various positions, including being distributed such that portions of functions are implemented at different physical locations by one or more physical devices. In some examples, AP communications manager 515 and/or at least some of its various sub-components may be a separate and distinct component in accordance with various aspects of the present disclosure. In other examples, AP communications manager 515 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

AP communications manager 515 may transmit a wakeup waveform including a first preamble portion occupying a first bandwidth. In some cases, the first preamble portion may include six or more orthogonal frequency division multiplexing (OFDM) symbols, the sixth one of which is un-rotated BPSK modulated. AP communications manager 515 may transmit a second wakeup portion of the wakeup waveform occupying a second bandwidth that is less than the first bandwidth. The AP communications manager 515 may also transmit, in a first bandwidth, a preamble of a wakeup waveform including a first preamble portion followed by a second preamble portion including an un-rotated BPSK modulated symbol. The AP communications manager 515 may then transmit, to a wakeup radio of a station and following the preamble occupying the first bandwidth, a wakeup signal of the wakeup waveform occupying a second bandwidth, the second bandwidth less than the first bandwidth.

Transmitter 520 may transmit signals generated by other components of the device. In some examples, the transmitter 520 may be collocated with a receiver 510 in a transceiver module. For example, the transmitter 520 may be an example of aspects of the transceiver 835 described with reference to FIG. 8. The transmitter 520 may include a single antenna, or it may include a set of antennas.

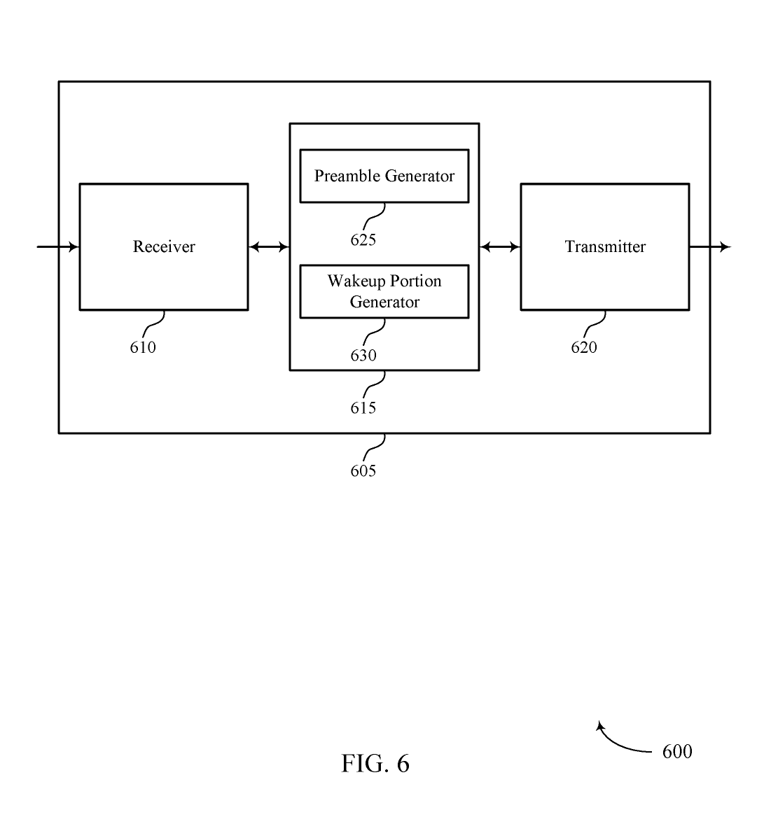

FIG. 6 shows a block diagram 600 of a wireless device 605 that supports improved wakeup receiver waveforms in accordance with various aspects of the present disclosure. Wireless device 605 may be an example of aspects of a wireless device 505 or an AP 105 as described with reference to FIGS. 1, 2, and 5. Wireless device 605 may include receiver 610, AP communications manager 615, and transmitter 620. Wireless device 605 may also include a processor. Each of these components may be in communication with one another (e.g., via one or more buses).

Receiver 610 may receive information such as packets, user data, or control information associated with various information channels (e.g., control channels, data channels, and information related to improved wakeup receiver waveforms, etc.). Information may be passed on to other components of the device. The receiver 610 may be an example of aspects of the transceiver 835 described with reference to FIG. 8.

AP communications manager 615 may be an example of aspects of the AP communications manager 815 described with reference to FIG. 8. AP communications manager 615 may also include preamble generator 625 and wakeup portion generator 630.

Preamble generator 625 may transmit a wakeup waveform including a first preamble portion occupying a first bandwidth. In some cases, the first preamble portion may include six or more OFDM symbols, the sixth one of which is un-rotated BPSK modulated. Preamble generator 625 may transmit, in a first bandwidth, a preamble of a wakeup waveform including a first preamble portion followed by a second preamble portion including an un-rotated BPSK modulated symbol. In some cases, the second preamble portion includes an indication of a presence of the wakeup signal following the preamble. In some cases, the length indication in the legacy signal field is not a multiple of 3 (e.g., not a multiple of 3 bytes). In some cases, the first bandwidth is 20 MHz. In some cases, the first preamble portion is targeted to one or more bystander stations. In some cases, symbols in the first preamble portion after the fifth OFDM symbol carry an identifier for a subset of the one or more bystander stations to detect the waveform as the wakeup waveform (e.g., the wakeup waveform as the wakeup waveform). In some cases, the first preamble portion includes a legacy short training field, a legacy long training field and a legacy signal field. In some cases, symbols in the first preamble portion after the fifth OFDM symbol carry information for the subset of the one or more bystander stations. In some cases, the information includes a BSS color as defined in IEEE 802.11ax or another BSS identifier. In some cases, the sixth OFDM symbol is different than the fifth OFDM symbol. In some cases, the identifier consists of one or more CRC bits, a masked RL-SIG as the sixth symbol, or a combination thereof.

Wakeup portion generator 630 may transmit a second wakeup portion of the wakeup waveform occupying a second bandwidth that is less than the first bandwidth and transmit, to a wakeup radio of a station and following the preamble occupying the first bandwidth, a wakeup signal of the wakeup waveform occupying a second bandwidth (e.g., the second bandwidth less than the first bandwidth). In some cases, the second bandwidth is less than 5 MHz.

Transmitter 620 may transmit signals generated by other components of the device. In some examples, the transmitter 620 may be collocated with a receiver 610 in a transceiver module. For example, the transmitter 620 may be an example of aspects of the transceiver 835 described with reference to FIG. 8. The transmitter 620 may include a single antenna, or it may include a set of antennas.

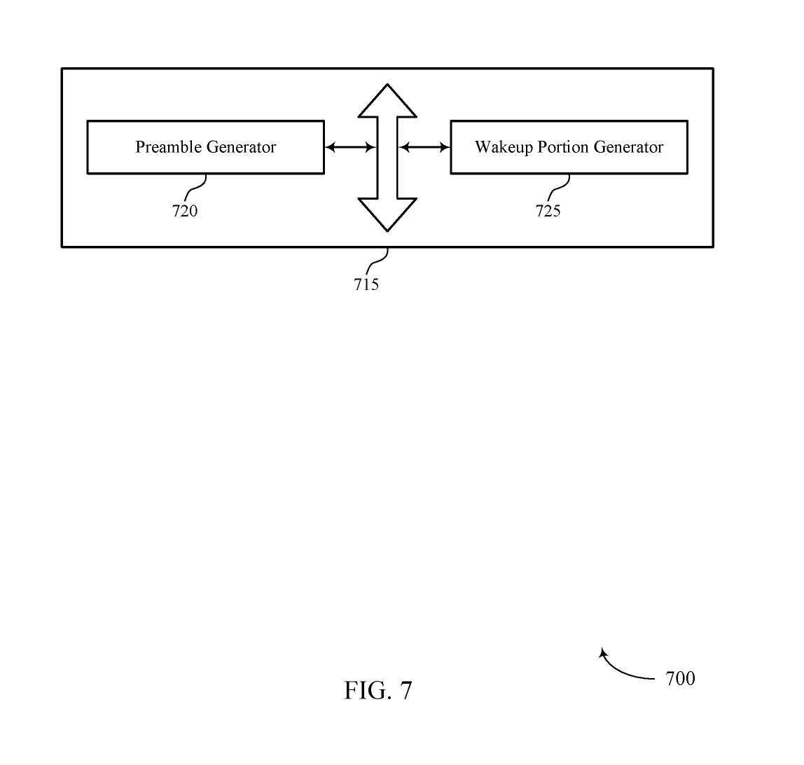

FIG. 7 shows a block diagram 700 of an AP communications manager 715 that supports improved wakeup receiver waveforms in accordance with various aspects of the present disclosure. The AP communications manager 715 may be an example of aspects of an AP communications manager 515, an AP communications manager 615, or an AP communications manager 815 described with reference to FIGS. 5, 6, and 8. The AP communications manager 715 may include preamble generator 720 and wakeup portion generator 725. Each of these modules may communicate, directly or indirectly, with one another (e.g., via one or more buses).

Preamble generator 720 may transmit a wakeup waveform including a first preamble portion occupying a first bandwidth. In some cases, the first preamble portion may include six or more OFDM symbols, the sixth one of which is un-rotated BPSK modulated. Preamble generator 720 may transmit, in a first bandwidth, a preamble of a wakeup waveform including a first preamble portion followed by a second preamble portion including an un-rotated BPSK modulated symbol. In some cases, the second preamble portion includes an indication of a presence of the wakeup signal following the preamble. In some cases, the length indication in the legacy signal field is not a multiple of 3. In some cases, the first bandwidth is 20 MHz. In some cases, the first preamble portion is targeted to one or more bystander stations. In some cases, symbols in the first preamble portion after the fifth OFDM symbol carry an identifier for a subset of the one or more bystander stations to detect the waveform as the wakeup waveform. In some cases, the first preamble portion includes a legacy short training field, a legacy long training field and a legacy signal field. In some cases, symbols in the first preamble portion after the fifth OFDM symbol carry information for the subset of the one or more bystander stations. In some cases, the information includes a BSS color as defined in IEEE 802.11ax or another BSS identifier. In some cases, the sixth OFDM symbol is different than the fifth OFDM symbol. In some cases, the identifier consists of one or more CRC bits, a masked RL-SIG as the sixth symbol, or a combination thereof.

Wakeup portion generator 725 may transmit a second wakeup portion of the wakeup waveform occupying a second bandwidth that is less than the first bandwidth and transmit, to a wakeup radio of a station and following the preamble occupying the first bandwidth, a wakeup signal of the wakeup waveform occupying a second bandwidth, the second bandwidth less than the first bandwidth. In some cases, the second bandwidth is less than 5 MHz.

FIG. 8 shows a diagram of a system 800 including a device 805 that supports improved wakeup receiver waveforms in accordance with various aspects of the present disclosure. Device 805 may be an example of or include the components of wireless device 505, wireless device 605, or an AP 105 as described above, e.g., with reference to FIGS. 1, 2, 5, and 6. Device 805 may include components for bi-directional voice and data communications including components for transmitting and receiving communications, including AP communications manager 815, processor 820, memory 825, software 830, transceiver 835, antenna 840, and I/O controller 845. These components may be in electronic communication via one or more busses (e.g., bus 810).

Processor 820 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, processor 820 may be configured to operate a memory array using a memory controller. In other cases, a memory controller may be integrated into processor 820. Processor 820 may be configured to execute computer-readable instructions stored in a memory to perform various functions (e.g., functions or tasks supporting improved wakeup receiver waveforms).

Memory 825 may include random access memory (RAM) and read only memory (ROM). The memory 825 may store computer-readable, computer-executable software 830 including instructions that, when executed, cause the processor to perform various functions described herein. In some cases, the memory 825 may contain, among other things, a basic input/output system (BIOS) which may control basic hardware and/or software operation such as the interaction with peripheral components or devices.

Software 830 may include code to implement aspects of the present disclosure, including code to support improved wakeup receiver waveforms. Software 830 may be stored in a non-transitory computer-readable medium such as system memory or other memory. In some cases, the software 830 may not be directly executable by the processor but may cause a computer (e.g., when compiled and executed) to perform functions described herein.

Transceiver 835 may communicate bi-directionally, via one or more antennas, wired, or wireless links as described above. For example, the transceiver 835 may represent a wireless transceiver and may communicate bi-directionally with another wireless transceiver. The transceiver 835 may also include a modem to modulate the packets and provide the modulated packets to the antennas for transmission, and to demodulate packets received from the antennas.

In some cases, the wireless device may include a single antenna 840. However, in some cases the device may have more than one antenna 840, which may be capable of concurrently transmitting or receiving multiple wireless transmissions.

I/O controller 845 may manage input and output signals for device 805. I/o controller 845 may also manage peripherals not integrated into device 805. In some cases, I/O controller 845 may represent a physical connection or port to an external peripheral. In some cases, I/O controller 845 may utilize an operating system such as iOS®, ANDROID®, MS-DOS®, MS-WINDOWS®, OS/2®, UNIX®, LINUX®, or another known operating system. In other cases, I/O controller 845 may represent or interact with a modem, a keyboard, a mouse, a touchscreen, or a similar device. In some cases, I/O controller 845 may be implemented as part of a processor. In some cases, a user may interact with device 805 via I/O controller 845 or via hardware components controlled by I/O controller 845.

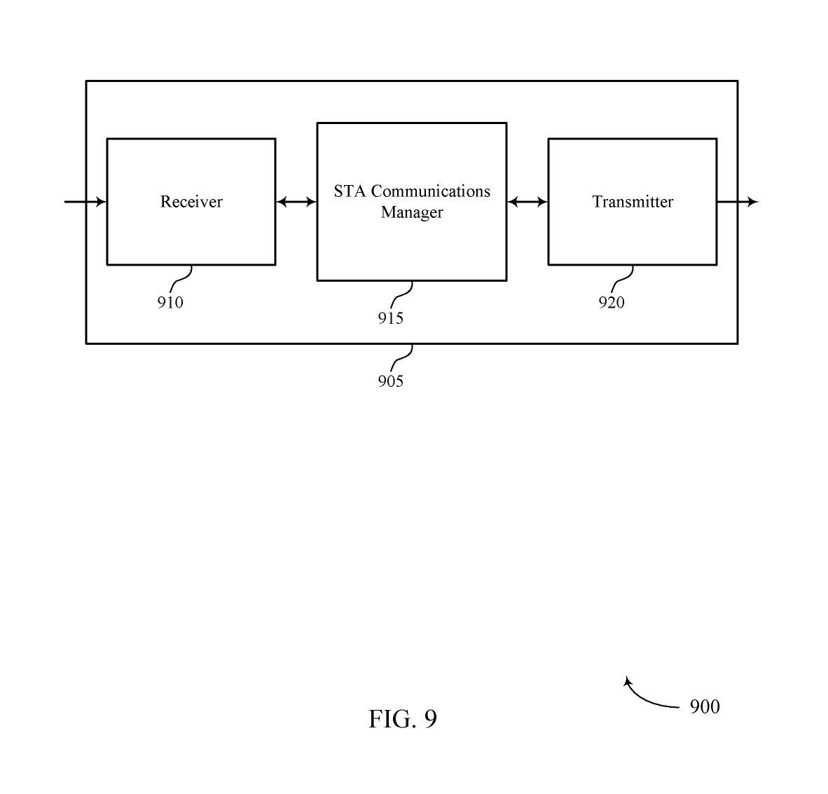

FIG. 9 shows a block diagram 900 of a wireless device 905 that supports improved wakeup receiver waveforms in accordance with various aspects of the present disclosure. Wireless device 905 may be an example of aspects of a STA 115 as described with reference to FIGS. 1 and 2. Wireless device 905 may include receiver 910, STA communications manager 915, and transmitter 920. Wireless device 905 may also include a processor. Each of these components may be in communication with one another (e.g., via one or more buses).

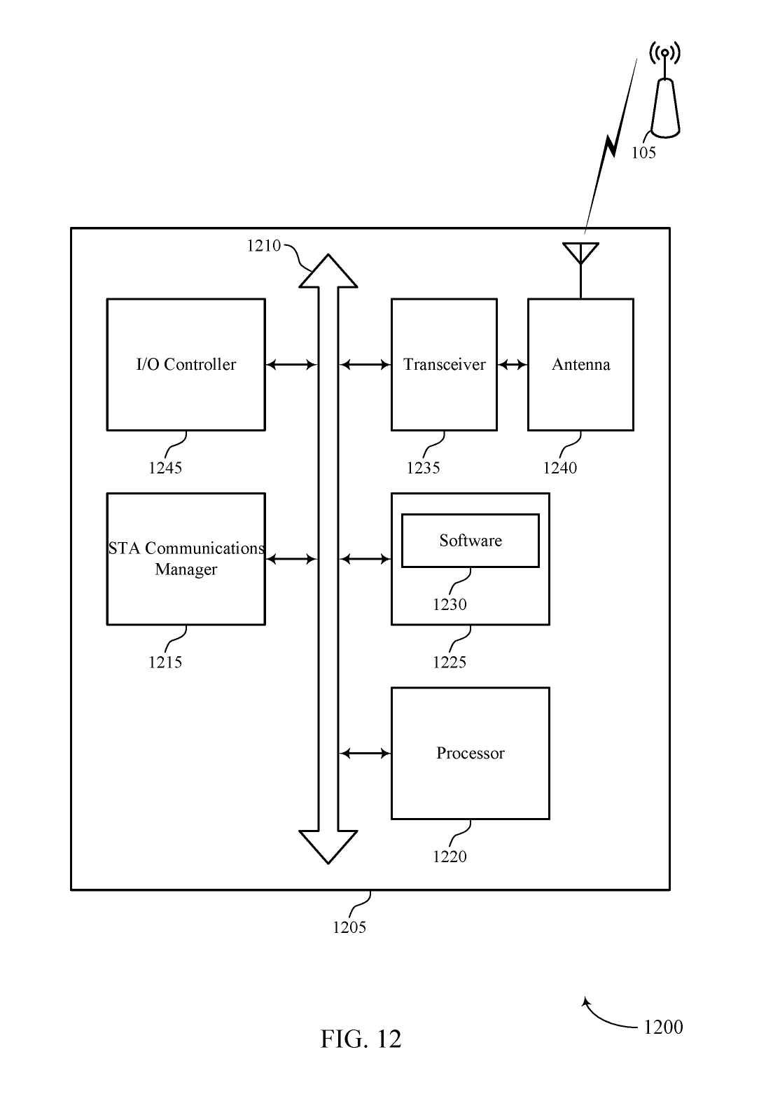

Receiver 910 may receive information such as packets, user data, or control information associated with various information channels (e.g., control channels, data channels, and information related to improved wakeup receiver waveforms, etc.). Information may be passed on to other components of the device. The receiver 910 may be an example of aspects of the transceiver 1235 described with reference to FIG. 12. Receiver 910 may receive a preamble, the preamble occupying a first bandwidth. In some cases, the preamble includes six or more OFDM symbols, the sixth OFDM symbol being the un-rotated BPSK modulated symbol. In some cases, the first bandwidth is 20 MHz.

STA communications manager 915 may be an example of aspects of the STA communications manager 1215 described with reference to FIG. 12. STA communications manager 915 and/or at least some of its various sub-components may be implemented in hardware, software executed by a processor, firmware, or any combination thereof. If implemented in software executed by a processor, the functions of the STA communications manager 915 and/or at least some of its various sub-components may be executed by a general-purpose processor, a DSP, an ASIC, an FPGA or other programmable logic device, discrete gate or transistor logic, discrete hardware components, or any combination thereof designed to perform the functions described in the present disclosure. The STA communications manager 915 and/or at least some of its various sub-components may be physically located at various positions, including being distributed such that portions of functions are implemented at different physical locations by one or more physical devices. In some examples, STA communications manager 915 and/or at least some of its various sub-components may be a separate and distinct component in accordance with various aspects of the present disclosure. In other examples, STA communications manager 915 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

STA communications manager 915 may identify an un-rotated BPSK modulated symbol following a first preamble portion in the received preamble and detect that the preamble is associated with a wakeup waveform based on the identified un-rotated BPSK modulated symbol.

Transmitter 920 may transmit signals generated by other components of the device. In some examples, the transmitter 920 may be collocated with a receiver 910 in a transceiver module. For example, the transmitter 920 may be an example of aspects of the transceiver 1235 described with reference to FIG. 12. The transmitter 920 may include a single antenna, or it may include a set of antennas.

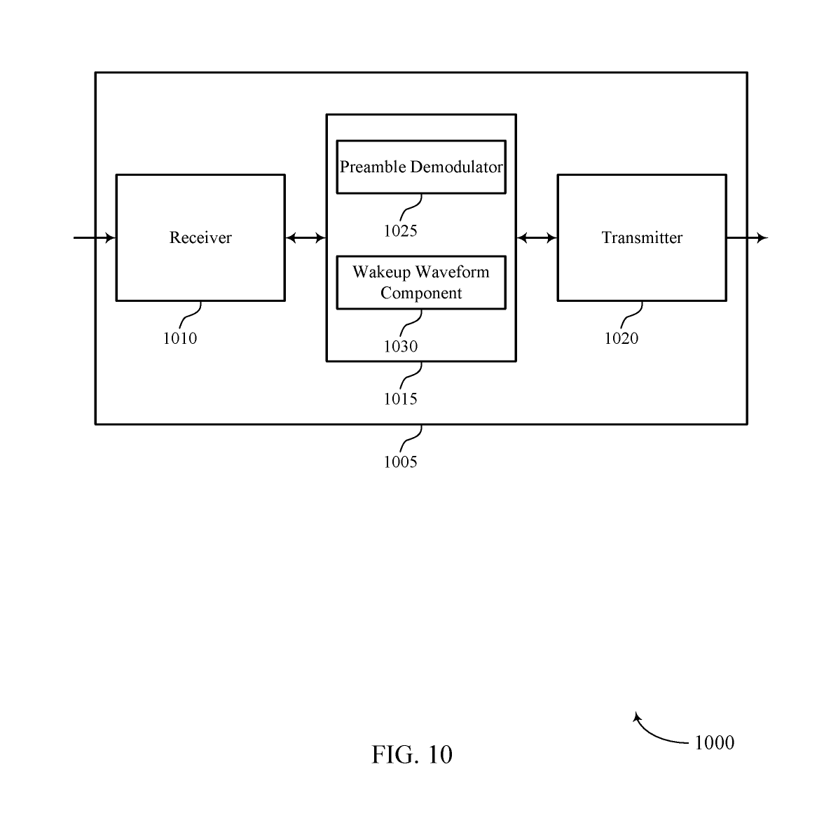

FIG. 10 shows a block diagram 1000 of a wireless device 1005 that supports improved wakeup receiver waveforms in accordance with various aspects of the present disclosure. Wireless device 1005 may be an example of aspects of a wireless device 905 or a STA 115 as described with reference to FIGS. 1, 2, and 9. Wireless device 1005 may include receiver 1010, STA communications manager 1015, and transmitter 1020. Wireless device 1005 may also include a processor. Each of these components may be in communication with one another (e.g., via one or more buses).

Receiver 1010 may receive information such as packets, user data, or control information associated with various information channels (e.g., control channels, data channels, and information related to improved wakeup receiver waveforms, etc.). Information may be passed on to other components of the device. The receiver 1010 may be an example of aspects of the transceiver 1235 described with reference to FIG. 12.

STA communications manager 1015 may be an example of aspects of the STA communications manager 1215 described with reference to FIG. 12. STA communications manager 1015 may also include preamble demodulator 1025 and wakeup waveform component 1030.

Preamble demodulator 1025 may identify an un-rotated BPSK modulated symbol following a first preamble portion in the received preamble. In some cases, the first preamble portion includes a legacy short training field, a legacy long training field and a legacy signal field. In some cases, the length indication in the legacy signal field is not a multiple of 3. In some cases, the first preamble portion is targeted to the station. In some cases, symbols in the first preamble portion after the fifth OFDM symbol carry an identifier for the station to detect the waveform as the wakeup waveform. In some cases, the identifier consists of one or more CRC bits, a masked RL-SIG as the sixth symbol, or a combination thereof.

Wakeup waveform component 1030 may detect that the preamble is associated with a wakeup waveform based on the identified un-rotated BPSK modulated symbol. In some cases, the sixth OFDM symbol is different than the fifth OFDM symbol.

Transmitter 1020 may transmit signals generated by other components of the device. In some examples, the transmitter 1020 may be collocated with a receiver 1010 in a transceiver module. For example, the transmitter 1020 may be an example of aspects of the transceiver 1235 described with reference to FIG. 12. The transmitter 1020 may include a single antenna, or it may include a set of antennas.

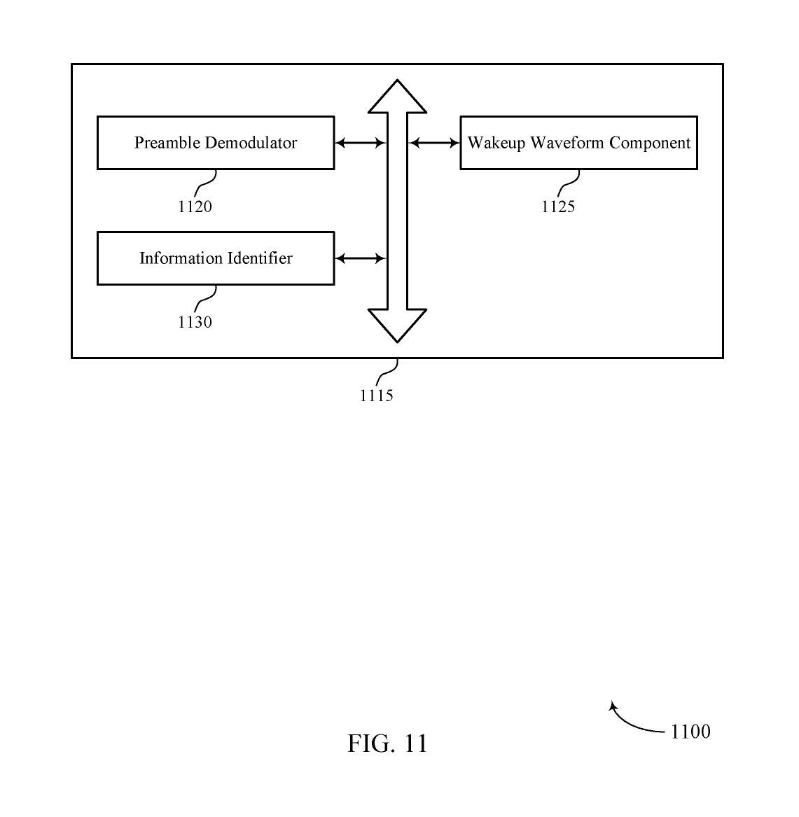

FIG. 11 shows a block diagram 1100 of a STA communications manager 1115 that supports improved wakeup receiver waveforms in accordance with various aspects of the present disclosure. The STA communications manager 1115 may be an example of aspects of a STA communications manager 1215 described with reference to FIGS. 9, 10, and 12. The STA communications manager 1115 may include preamble demodulator 1120, wakeup waveform component 1125, and information identifier 1130. Each of these modules may communicate, directly or indirectly, with one another (e.g., via one or more buses).

Preamble demodulator 1120 may identify an un-rotated BPSK modulated symbol following a first preamble portion in the received preamble. In some cases, the first preamble portion includes a legacy short training field, a legacy long training field and a legacy signal field. In some cases, the length indication in the legacy signal field is not a multiple of 3. In some cases, the first preamble portion is targeted to the station. In some cases, symbols in the first preamble portion after the fifth OFDM symbol carry an identifier for the station to detect the waveform as the wakeup waveform. In some cases, the identifier consists of one or more CRC bits, a masked RL-SIG as the sixth symbol, or a combination thereof.

Wakeup waveform component 1125 may detect that the preamble is associated with a wakeup waveform based on the identified un-rotated BPSK modulated symbol. In some cases, the sixth OFDM symbol is different than the fifth OFDM symbol.

Information identifier 1130 may identify additional information included in the wakeup waveform. In some cases, symbols in the first preamble portion after the fifth OFDM symbol carry information for the station. In some cases, the information includes a BSS color as defined in IEEE 802.11ax or another BSS identifier.

FIG. 12 shows a diagram of a system 1200 including a device 1205 that supports improved wakeup receiver waveforms in accordance with various aspects of the present disclosure. Device 1205 may be an example of or include the components of STA 115 as described above, e.g., with reference to FIGS. 1 and 2. Device 1205 may include components for bi-directional voice and data communications including components for transmitting and receiving communications, including STA communications manager 1215, processor 1220, memory 1225, software 1230, transceiver 1235, antenna 1240, and I/O controller 1245. These components may be in electronic communication via one or more busses (e.g., bus 1210).

Processor 1220 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, processor 1220 may be configured to operate a memory array using a memory controller. In other cases, a memory controller may be integrated into processor 1220. Processor 1220 may be configured to execute computer-readable instructions stored in a memory to perform various functions (e.g., functions or tasks supporting improved wakeup receiver waveforms).

Memory 1225 may include RAM and ROM. The memory 1225 may store computer-readable, computer-executable software 1230 including instructions that, when executed, cause the processor to perform various functions described herein. In some cases, the memory 1225 may contain, among other things, a BIOS which may control basic hardware and/or software operation such as the interaction with peripheral components or devices.

Software 1230 may include code to implement aspects of the present disclosure, including code to support improved wakeup receiver waveforms. Software 1230 may be stored in a non-transitory computer-readable medium such as system memory or other memory. In some cases, the software 1230 may not be directly executable by the processor but may cause a computer (e.g., when compiled and executed) to perform functions described herein.

Transceiver 1235 may communicate bi-directionally, via one or more antennas, wired, or wireless links as described above. For example, the transceiver 1235 may represent a wireless transceiver and may communicate bi-directionally with another wireless transceiver. The transceiver 1235 may also include a modem to modulate the packets and provide the modulated packets to the antennas for transmission, and to demodulate packets received from the antennas.

In some cases, the wireless device may include a single antenna 1240. However, in some cases the device may have more than one antenna 1240, which may be capable of concurrently transmitting or receiving multiple wireless transmissions.

I/O controller 1245 may manage input and output signals for device 1205. I/O controller 1245 may also manage peripherals not integrated into device 1205. In some cases, I/O controller 1245 may represent a physical connection or port to an external peripheral. In some cases, I/O controller 1245 may utilize an operating system such as iOS®, ANDROID®, MS-DOS®, MS-WINDOWS®, OS/2®, UNIX®, LINUX®, or another known operating system. In other cases, I/O controller 1245 may represent or interact with a modem, a keyboard, a mouse, a touchscreen, or a similar device. In some cases, I/O controller 1245 may be implemented as part of a processor. In some cases, a user may interact with device 1205 via I/O controller 1245 or via hardware components controlled by I/O controller 1245.

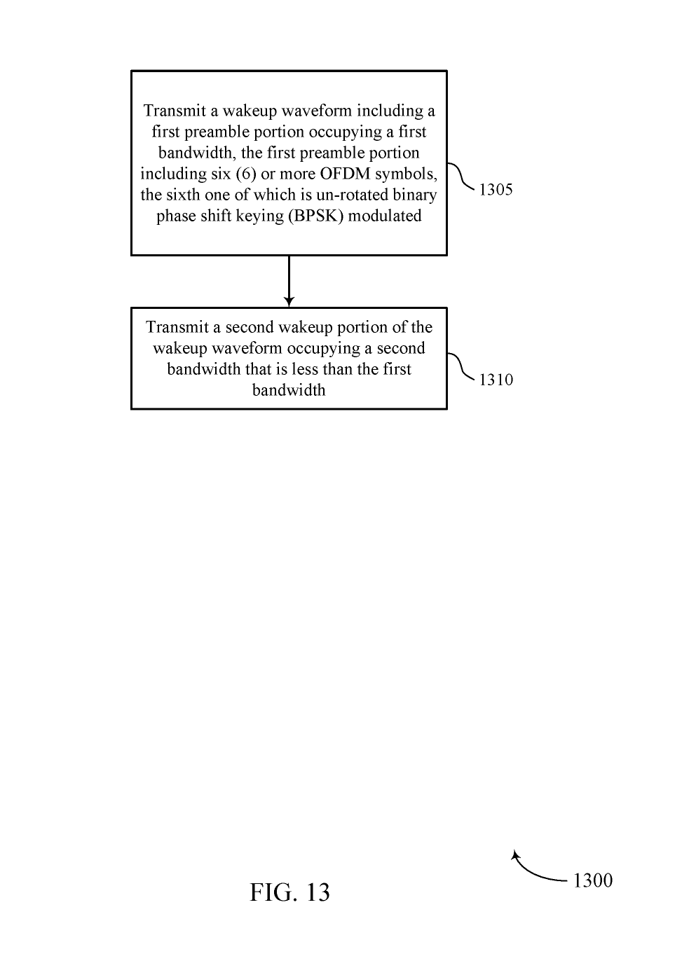

FIG. 13 shows a flowchart illustrating a method 1300 for improved wakeup receiver waveforms in accordance with various aspects of the present disclosure. The operations of method 1300 may be implemented by an AP 105 or its components as described herein. For example, the operations of method 1300 may be performed by an AP communications manager as described with reference to FIGS. 5 through 8. In some examples, an AP 105 may execute a set of codes to control the functional elements of the device to perform the functions described below. Additionally or alternatively, the AP 105 may perform aspects of the functions described below using special-purpose hardware.

At block 1305 the AP 105 may transmit a wakeup waveform comprising a first preamble portion occupying a first bandwidth. In some cases, the first preamble portion may comprise six or more OFDM symbols, the sixth one of which is un-rotated BPSK modulated. The operations of block 1305 may be performed according to the methods described with reference to FIGS. 1 through 4. In certain examples, aspects of the operations of block 1305 may be performed by a preamble generator as described with reference to FIGS. 5 through 8.

At block 1310 the AP 105 may transmit a second wakeup portion of the wakeup waveform occupying a second bandwidth that is less than the first bandwidth. The operations of block 1310 may be performed according to the methods described with reference to FIGS. 1 through 4. In certain examples, aspects of the operations of block 1310 may be performed by a wakeup portion generator as described with reference to FIGS. 5 through 8.

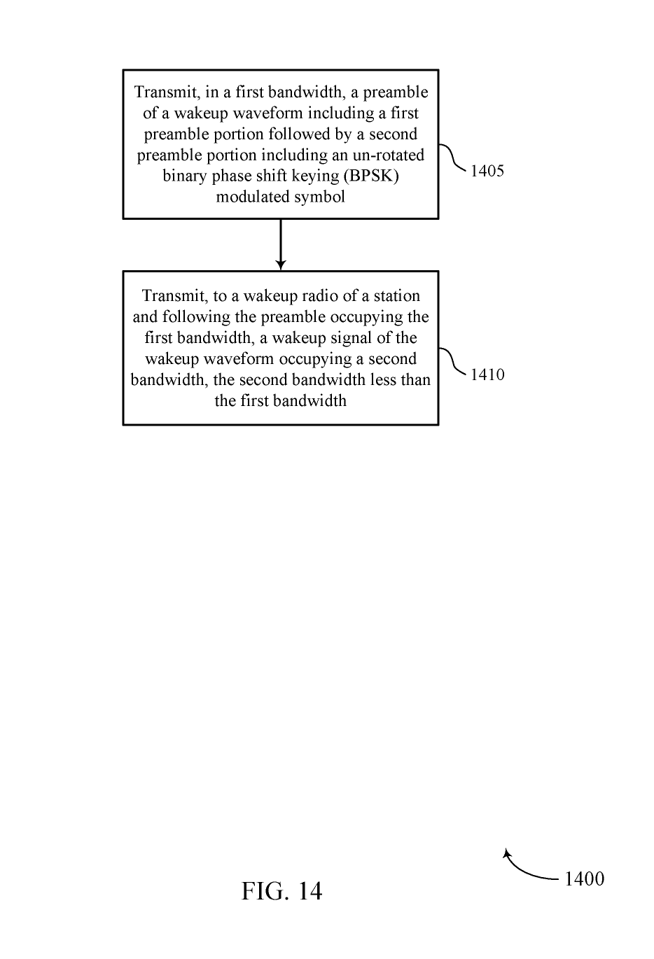

FIG. 14 shows a flowchart illustrating a method 1400 for improved wakeup receiver waveforms in accordance with various aspects of the present disclosure. The operations of method 1400 may be implemented by an AP 105 or its components as described herein. For example, the operations of method 1400 may be performed by an AP communications manager as described with reference to FIGS. 5 through 8. In some examples, an AP 105 may execute a set of codes to control the functional elements of the device to perform the functions described below. Additionally or alternatively, the AP 105 may perform aspects of the functions described below using special-purpose hardware.

At block 1405 the AP 105 may transmit, in a first bandwidth, a preamble of a wakeup waveform including a first preamble portion followed by a second preamble portion comprising an un-rotated BPSK modulated symbol. The operations of block 1405 may be performed according to the methods described with reference to FIGS. 1 through 4. In certain examples, aspects of the operations of block 1405 may be performed by a preamble generator as described with reference to FIGS. 5 through 8.

At block 1410 the AP 105 may transmit, to a wakeup radio of a station and following the preamble occupying the first bandwidth, a wakeup signal of the wakeup waveform occupying a second bandwidth. In some cases, the second bandwidth may be less than the first bandwidth. The operations of block 1410 may be performed according to the methods described with reference to FIGS. 1 through 4. In certain examples, aspects of the operations of block 1410 may be performed by a wakeup portion generator as described with reference to FIGS. 5 through 8.

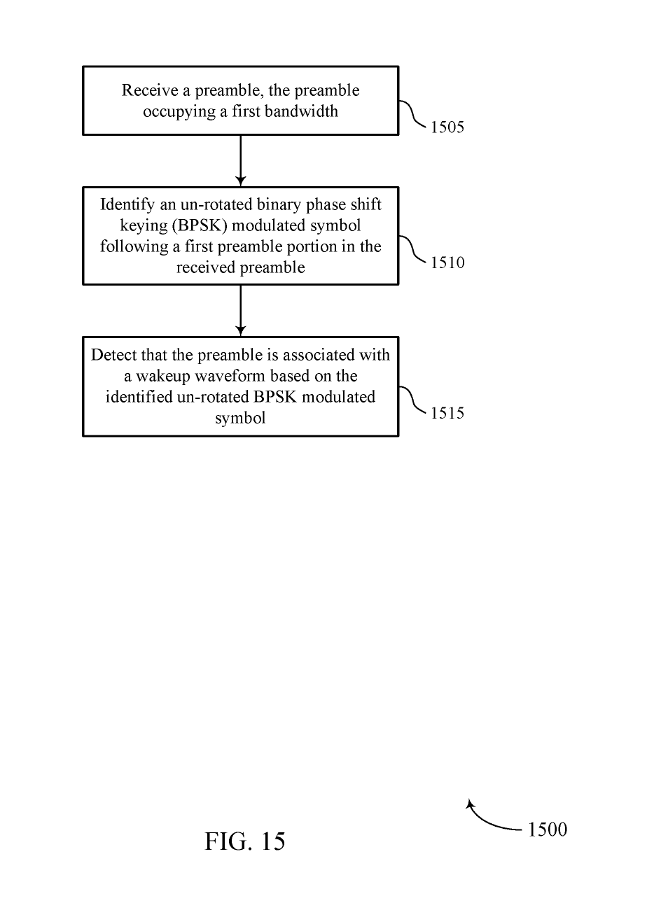

FIG. 15 shows a flowchart illustrating a method 1500 for improved wakeup receiver waveforms in accordance with various aspects of the present disclosure. The operations of method 1500 may be implemented by a STA 115 or its components as described herein. For example, the operations of method 1500 may be performed by a STA communications manager as described with reference to FIGS. 9 through 12. In some examples, a STA 115 may execute a set of codes to control the functional elements of the device to perform the functions described below. Additionally or alternatively, the STA 115 may perform aspects of the functions described below using special-purpose hardware.

At block 1505 the STA 115 may receive a preamble, the preamble occupying a first bandwidth. The operations of block 1505 may be performed according to the methods described with reference to FIGS. 1 through 4. In certain examples, aspects of the operations of block 1505 may be performed by a receiver as described with reference to FIGS. 9 through 12.

At block 1510 the STA 115 may identify an un-rotated BPSK modulated symbol following a first preamble portion in the received preamble. The operations of block 1510 may be performed according to the methods described with reference to FIGS. 1 through 4. In certain examples, aspects of the operations of block 1510 may be performed by a preamble demodulator as described with reference to FIGS. 9 through 12.

At block 1515 the STA 115 may detect that the preamble is associated with a wakeup waveform based at least in part on the identified un-rotated BPSK modulated symbol. The operations of block 1515 may be performed according to the methods described with reference to FIGS. 1 through 4. In certain examples, aspects of the operations of block 1515 may be performed by a wakeup waveform component as described with reference to FIGS. 9 through 12.

It should be noted that the methods described above describe possible implementations, and that the operations and the steps may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM). An orthogonal frequency division multiple access (OFDMA) system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc.

The wireless communications system or systems described herein may support synchronous or asynchronous operation. For synchronous operation, the stations may have similar frame timing, and transmissions from different stations may be approximately aligned in time. For asynchronous operation, the stations may have different frame timing, and transmissions from different stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, WLAN 100 and wireless communications system 200 of FIGS. 1 and 2—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof If implemented in software executed by a processor, the functions may be stored on or transmitted over as one or more instructions or code on a computer-readable medium. Other examples and implementations are within the scope of the disclosure and appended claims. For example, due to the nature of software, functions described above may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communication, comprising:
transmitting, at an access point (AP), a wakeup waveform comprising a first preamble portion occupying a first bandwidth, the first preamble portion comprising six (6) or more orthogonal frequency division multiplexing (OFDM) symbols, the sixth one of which is un-rotated binary phase shift keying (BPSK) modulated; and
transmitting a second wakeup portion of the wakeup waveform occupying a second bandwidth that is less than the first bandwidth.

2. The method of claim 1, wherein the first preamble portion includes a legacy short training field, a legacy long training field and a legacy signal field.

3. The method of claim 2, wherein a length indication in the legacy signal field is not a multiple of 3.

4. The method of claim 1, wherein the first bandwidth is 20 MHz.

5. The method of claim 1, wherein the second bandwidth is less than 5 MHz.

6. The method of claim 1, wherein symbols in the first preamble portion after the fifth OFDM symbol carry an identifier for one or more bystander stations to detect the wakeup waveform as the wakeup waveform.

7. The method of claim 6, wherein the identifier consists of one or more cyclic redundancy check (CRC) bits, a masked repeated legacy signal field (RL-SIG) as the sixth symbol, or a combination thereof.

8. The method of claim 6, wherein symbols in the first preamble portion after the fifth OFDM symbol carry information for at least one of the one or more bystander stations.

9. The method of claim 8, wherein the information comprises a basic service set (BSS) color as defined in Institute of Electrical and Electronics Engineers (IEEE) 802.11ax or another BSS identifier.

10. A method for wireless communication, comprising:
receiving a preamble, the preamble occupying a first bandwidth;
identifying an un-rotated binary phase shift keying (BPSK) modulated symbol following a first preamble portion in the received preamble; and
detecting that the preamble is associated with a wakeup waveform based at least in part on the identified un-rotated BPSK modulated symbol.

11. The method of claim 10, wherein the preamble comprises six (6) or more orthogonal frequency division multiplexing (OFDM) symbols, the sixth OFDM symbol being the un-rotated BPSK modulated symbol.

12. The method of claim 10, wherein the first preamble portion includes a legacy short training field, a legacy long training field and a legacy signal field.

13. The method of claim 12, wherein a length indication in the legacy signal field is not a multiple of 3.

14. The method of claim 10, wherein the first bandwidth is 20 MHz.

15. The method of claim 10, wherein symbols in the first preamble portion after a fifth orthogonal frequency division multiplexing (OFDM) symbol carry an identifier used to detect the wakeup waveform as the wakeup waveform.

16. The method of claim 15, wherein the identifier consists of one or more cyclic redundancy check (CRC) bits, a masked repeated legacy signal field (RL-SIG) as the sixth symbol, or a combination thereof.

17. The method of claim 15, wherein symbols in the first preamble portion after the fifth OFDM symbol carry information.

18. The method of claim 17, wherein the information comprises a basic service set (BSS) color as defined in Institute of Electrical and Electronics Engineers (IEEE) 802.11ax or another BSS identifier.

19. An apparatus for wireless communication, in a system comprising:
a processor;
memory in electronic communication with the processor; and
instructions stored in the memory and operable, when executed by the processor, to cause the apparatus to:
transmit, at an access point (AP), a wakeup waveform comprising a first preamble portion occupying a first bandwidth, the first preamble portion comprising six (6) or more orthogonal frequency division multiplexing (OFDM) symbols, the sixth one of which is un-rotated binary phase shift keying (BPSK) modulated; and
transmit a second wakeup portion of the wakeup waveform occupying a second bandwidth that is less than the first bandwidth.

20. The apparatus of claim 19, wherein the first preamble portion includes a legacy short training field, a legacy long training field and a legacy signal field.

21. The apparatus of claim 20, wherein a length indication in the legacy signal field is not a multiple of 3.

22. The apparatus of claim 19, wherein the first bandwidth is 20 MHz.

23. The apparatus of claim 19, wherein the second bandwidth is less than 5 MHz.

24. The apparatus of claim 19, wherein symbols in the first preamble portion after the fifth OFDM symbol carry an identifier for one or more bystander stations to detect the wakeup waveform as the wakeup waveform.

25. The apparatus of claim 24, wherein the identifier consists of one or more cyclic redundancy check (CRC) bits, a masked repeated legacy signal field (RL-SIG) as the sixth symbol, or a combination thereof.

26. The apparatus of claim 24, wherein symbols in the first preamble portion after the fifth OFDM symbol carry information for at least one of the one or more bystander stations.

27. The apparatus of claim 26, wherein the information comprises a basic service set (BSS) color as defined in Institute of Electrical and Electronics Engineers (IEEE) 802.11ax or another BSS identifier.

28. An apparatus for wireless communication, in a system comprising:
a processor;
memory in electronic communication with the processor; and
instructions stored in the memory and operable, when executed by the processor, to cause the apparatus to:
receive a preamble, the preamble occupying a first bandwidth;
identify an un-rotated binary phase shift keying (BPSK) modulated symbol following a first preamble portion in the received preamble; and
detect that the preamble is associated with a wakeup waveform based at least in part on the identified un-rotated BPSK modulated symbol.

29. The apparatus of claim 28, wherein the preamble comprises six (6) or more orthogonal frequency division multiplexing (OFDM) symbols, the sixth OFDM symbol being the un-rotated BPSK modulated symbol.

30. The apparatus of claim 28, wherein the first bandwidth is 20 MHz.
